(19) United States
(12) Patent Application Publication
(10) Pub. No.: US 2010/0232364 A1
(43) Pub. Date: Sep. 16, 2010

(54) METHOD OF HANDLING RANDOM ACCESS PROCEDURE AND RELATED COMMUNICATION DEVICE

(76) Inventor: Chia-Chun Hsu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/724,433

(22) Filed: Mar. 16, 2010

Related U.S. Application Data
(60) Provisional application No. 61/160,345, filed on Mar. 16, 2009.

(51) Int. Cl. H04W 74/08

(52) U.S. Cl. 370/328

(57) ABSTRACT

A method of handling a random access procedure for a mobile device in a wireless communication system is disclosed. The method of handling the random access procedure comprises the steps of applying a backoff parameter value associated with the random access procedure according to an operation mode of the mobile device and selecting a backoff time according to a uniform distribution between 0 and the backoff parameter value.

### CROSS REFERENCE TO RELATED APPLICATIONS

This application claims the benefit of U.S. Provisional Application No. 61/160,345, filed on Mar. 16, 2009 and entitled “METHOD AND APPARATUS FOR HANDLING RANDOM ACCESS RESPONSE IN A WIRELESS COMMUNICATIONS SYSTEM” the contents of which are incorporated herein.

### BACKGROUND OF THE INVENTION

1. Field of the Invention

The present invention relates to a method and related communication device in a wireless communication system, and more particularly, to a method of handling a random access procedure for a mobile device in a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

A UE in the LTE system can only be scheduled for uplink transmission only if its uplink transmission timing is synchronized. When the UE has lost its uplink synchronization, a random access procedure may be needed, which plays a key role as an interface between the non-synchronized UE and the LTE uplink transmission scheme. Once uplink synchronization is achieved for the UE, the eNB can schedule uplink transmission resource for it. Relevant scenarios in which the random access procedure may be initiated are described as follows:

(1) A UE in RRC_CONNECTED state, but not uplink-synchronized, needing to send new uplink data or control information (e.g. an event-triggered measurement report);

(2) A UE in RRC_CONNECTED state, but not uplink-synchronized, needing to receive new downlink data, and therefore to transmit corresponding ACK/NACK in the uplink;

(3) A UE in RRC_CONNECTED state, handing over from its current serving cell to a target cell;

(4) A transition from RRC_IDLE state to RRC_CONNECTED state, for example for initial access or tracking area updates;

(5) Recovering from radio link failure.

One additional exceptional case is that an uplink-synchronized UE is allowed to use a random access channel to send a scheduling request (SR) if it does not have any other uplink resource allocated in which to send the SR. The random access procedure comes in two forms, allowing access to be either contention based or non-contention based. The UE initiates the contention based random access procedure for all use-cases described above. Please refer to FIG. 1, which illustrates a contention based random access procedure in the prior art. In the contention based random access procedure, a random access preamble is randomly chosen by the UE and sent to the eNB (Step A). It is possible for one or more UEs simultaneously to transmit the same random access preamble, leading to a need for a subsequent contention resolution process. After receiving the random access preamble from the UE, the eNB sends a random access response on a physical downlink shared channel (PDSCH) to respond one or more UEs (Step B). The UE receives the random access responses from the eNB and extracts the information sent to the UE. The UE then sends a scheduled transmission on the uplink to the eNB according to the information received from the random access response (Step C). The eNB may send a message on the PDSCH for contention resolution. A collision of the message may occur when multiple UEs send the same random access preamble. The contention resolution therefore is perform to resolve which UE should be granted access (Step D).

The random access response carrying variable information (e.g. timing advance) may be sent in a media access control protocol data unit (MAC PDU). Please refer to FIG. 2, which is a schematic diagram of a MAC PDU in the prior art. As shown in FIG. 2, the MAC PDU consists of a MAC header and one or more random access responses (called MAC RARs hereinafter) and optionally padding. The MAC header is added at the beginning of a network packet in order to turn it into a frame ready for transmission over the network. The MAC header is of variable size and consists of one or more MAC subheaders (e.g. random access preamble identifier (RAPID) subheader). Each MAC subheader corresponds to a MAC RAR, except for a backoff indicator (BI) subheader. Please refer to FIG. 3, which is a schematic diagram of the MAC subheaders of the MAC PDU shown in FIG. 2. As shown in FIG. 3, the RAPID MAC subheader consists of three header fields E/T/RAPID. The BI subheader consists of five header fields E/T/R/R/BI. The E field represents the extension field, which is a flag indicating if more fields are present in the MAC header or not. The E field is set to “1” to indicate another set of at least E/T/RAPID or E/T/R/BI. The E field is set to “0” to indicate that a MAC RAR starts at the next byte. The T field, the type field, is a flag indicating whether the MAC subheader contains the RAPID or a backoff indicator. The T field is set to “0” to indicate the presence of the backoff indicator field in the BI subheader. The T filed is set to “1” to indicate the presence of the RAPID field in the subheader. The R field is a reserve bit, set to “0”. The BI filed, the backoff indicator field, identifies the overload condition in the cell. The size of the BI field is four bits. The RAPID field identifies a random access preamble previously transmitted by the UE for initiation of the random access procedure. The size of the RAPID field is six bits.

Please refer to FIG. 4, which is a schematic diagram of a MAC RAR in the prior art. The MAC RAR is of fixed size and consists of the following fields. AR field is a reserve bit, set to “0”. A timing advance (TA) command field indicates the index value T_{A} (0-1282) used to control the amount of timing adjustment that the UE has to apply. The size of the timing advance command field is eleven bits. An uplink grant field indicates the resources to be used on the uplink. The size of the uplink grant field is twenty bits. A temporary C-RNTI (cell-radio network temporary identifier) field indicates the temporary identity that is used by the UE during random access. The size of the Temporary C-RNTI field is sixteen bits. The temporary C-RNTI may be used as a C-RNTI if the UE does not already have the C-RNTI. The C-RNTI is a UE ID used to uniquely identify the UE to a cell and is valid for that cell for the duration of the connection.

When the UE having transmitted the random access preamble does not receive a random access response within a certain duration of time (referred to as random access window), or all received random access responses contain RAPIDs that do not match the transmitted random access preamble, the random access response reception is considered not successful and the UE should delay a period of time for the retransmission of the random access preamble. The period of time for delay may associate with a backoff value indicated by the BI subheader. The BI-subheader may be included in a MAC PDU that the UE received earlier. As described above, the random access procedure may be initiated by the UE in RRC_IDLE state or the UE in RRC_CONNECTED state. So far, the UE (regardless of the RRC_IDLE state or the RRC_CONNECTED state) applies the same backoff value indicated by the BI subheader to delay the retransmission of the random access preamble when the reception of random access response fails. However, transmission collision of the random access preamble more likely happens to the UE in the RRC_IDLE state than the UE in the RRC_CONNECTED state.

In addition, when the UEs of the multiple standard releases (e.g. Rel-8 UE, Rel-9 UE, Rel-10 UE . . . ), i.e. multiple RAT (Radio Access Technology) versions, coexist in the same E-UTRAN cell, UEs of all releases share the same backoff value. This may not distinguish the UEs running different standard releases. However, there may be substantial difference between different release systems in terms of transmission collision probabilities.

Another concerning is that the MAC PDU sent by the eNB may include one or more individual MAC RARs for one or more random access preambles received from one or more UEs. When the UEs of the multiple standard releases coexist in the same E-UTRAN cell, the eNB may combine pairs of RAPID subheader and MAC RAR for different releases in one MAC PDU. However, the MAC subheaders of the different releases may come in different formats. This may cause a problem for the UE to locate the correct MAC RAR with the matching release and ignore/discard those for other releases. Since a new format may be defined for the MAC RAR of the later releases, it is important for the UE to interpret the MAC RAR according to the correct format. In another example, the E-UTRAN may not mix RAPID subheader and MAC RAR pairs for different releases in one MAC PDU. Basically, the MAC PDU may be sent using a random access radio network temporary identifier (RA-RNTI) and the UE identifies its MAC PDU according to the RA-RNTI. In this situation, the UE may not be able to identify the MAC PDU of its release because the same RA-RNTI may be used on PDCCHs of different release UEs. This may cause ambiguity for the UE.

### SUMMARY OF THE INVENTION

A method of handling a random access response procedure for a mobile device in a wireless communication system is disclosed to avoid the aforementioned problems.

A method of handling a random access procedure for a mobile device in a wireless communication system is disclosed. The method of handling the random access procedure comprises the steps of applying a backoff parameter value associated with the random access procedure according to an operation mode of the mobile device and selecting a backoff time according to a uniform distribution between 0 and the backoff parameter value.

A method of handling a random access procedure for a mobile device using a radio access technology (RAT) version in a wireless communication system is disclosed. The method of handling the random access procedure comprises the steps of receiving a media access control protocol data unit (MAC PDU) associated with the random access procedure, wherein the MAC PDU comprises a plurality of backoff indicator (BI) subheaders and a plurality of reserved bit combinations corresponding to the plurality of BI subheaders; checking a first reserved bit combination corresponding to a first BI subheader; and applying a backoff parameter value indicated by the first BI subheader when the first reserved bit combination indicates the RAT version matching the RAT version of the mobile device.

A method of handling a random access procedure for a mobile device in a wireless communication system is disclosed. The method of handling the random access procedure comprises the steps of using a first radio access technology (RAT) version and receiving a media access control protocol data unit (MAC PDU) associated with the random access procedure, wherein the PDU comprises a plurality of backoff indicator (BI) subheaders or using a second RAT version and receiving the MAC PDU; applying a first backoff parameter value indicated by a first BI subheader or applying a second backoff parameter value indicated by a second BI subheader.

A method of handling a random access procedure for a mobile device in a wireless communication system is disclosed. The method of handling the random access procedure comprises the steps of receiving a media access control (MAC) protocol data unit (PDU) comprising a plurality of RAPID (random access preamble identifier) subheaders and a plurality of MAC random access responses (RARs) of the random access procedure, wherein each RAPID subheader corresponds to one MAC RAR and the plurality of MAC RARs correspond to a plurality of radio access technology (RAT) versions; determining a RAT version of a first MAC RAR according to a first RAPID subheader, first MAC RAR corresponding to the first RAPID subheader; and ignoring the first RAPID subheader and the first MAC RAR corresponding to the first RAPID when the RAT version of the first MAC RAR does not match the RAT version of the mobile device.

A method of handling a random access procedure for a mobile device in a wireless communication system is disclosed. The method of handling the random access procedure comprises the steps of receiving a media access control (MAC) protocol data unit (PDU) comprising at least one backoff indicator (BI) subheaders and a plurality of MAC random access responses (RARs) of the random access procedure, wherein the plurality of MAC RARs correspond to a single radio access technology (RAT) version; and determining a RAT version of the received MAC PDU according to the number of the BI subheaders of the received MAC PD.

A method of handling a random access procedure for a mobile device in a wireless communication system is disclosed. The method of handling the random access procedure comprises the steps of allocating radio resources according to radio access technology (RAT) versions of the plurality of mobile devices; recognizing the RAT versions of a plurality of mobile devices according to a RA feature of the plurality of mobile devices; and arranging a media access protocol data unit (MAC PDU) according the RAT versions of the plurality of mobile devices, wherein the MAC PDU comprises a plurality of RAPID (random access preamble identifier) subheaders and a plurality of MAC random access responses (RARs) of the random access procedure, each RAPID subheader corresponding to one MAC RAR and the plurality of MAC RARs corresponding to the plurality of the RAT versions.

These and other objectives will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a contention based random access procedure in the prior art.

FIG. 2 is a schematic diagram of a MAC PDU in the prior art.

FIG. 3 is a schematic diagram of the MAC subheaders of the MAC PDU shown in FIG. 2.

FIG. 4 is a schematic diagram of a MAC RAR in the prior art.

FIG. 5 is a schematic diagram of a wireless communication system according to an example.

FIG. 6 illustrates a schematic diagram of a communication device according to an example.

FIG. 7 illustrates a schematic diagram of a program code for the LTE system according to an example.

FIGS. 8˜15 are flowcharts of processes according to examples.

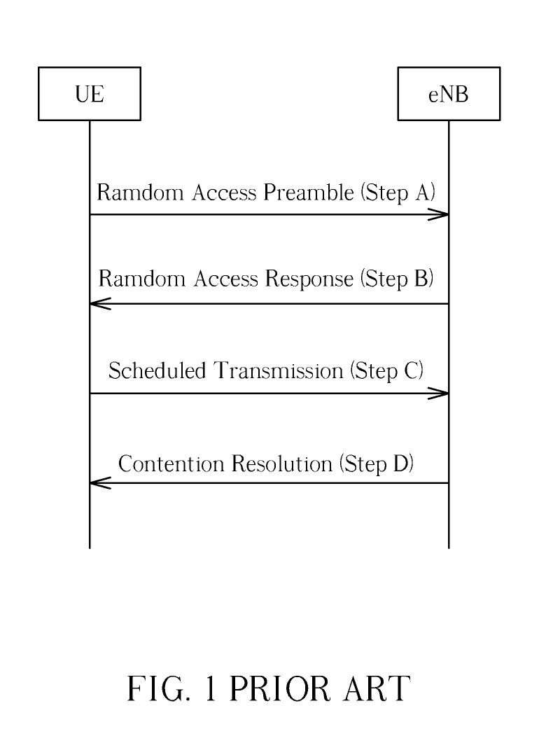

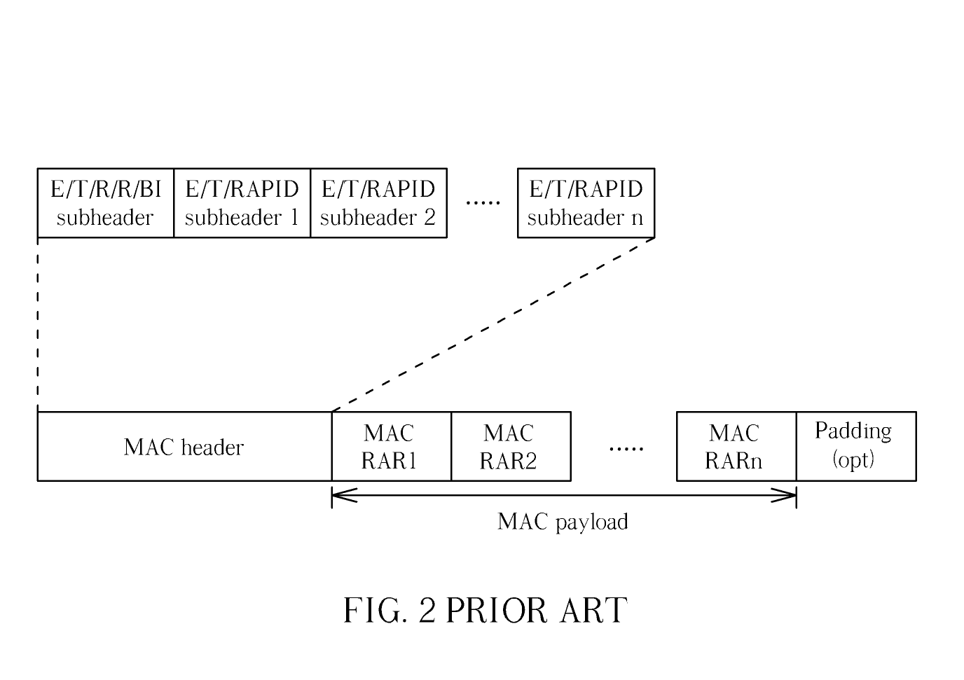

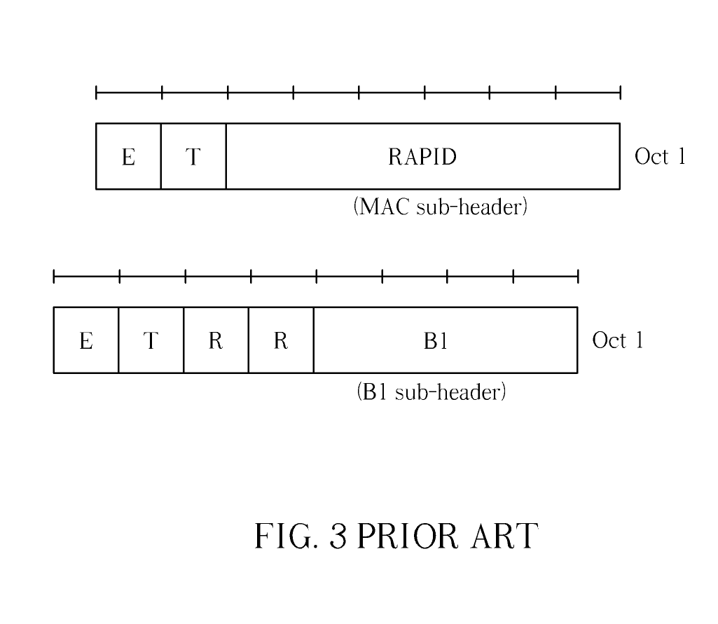

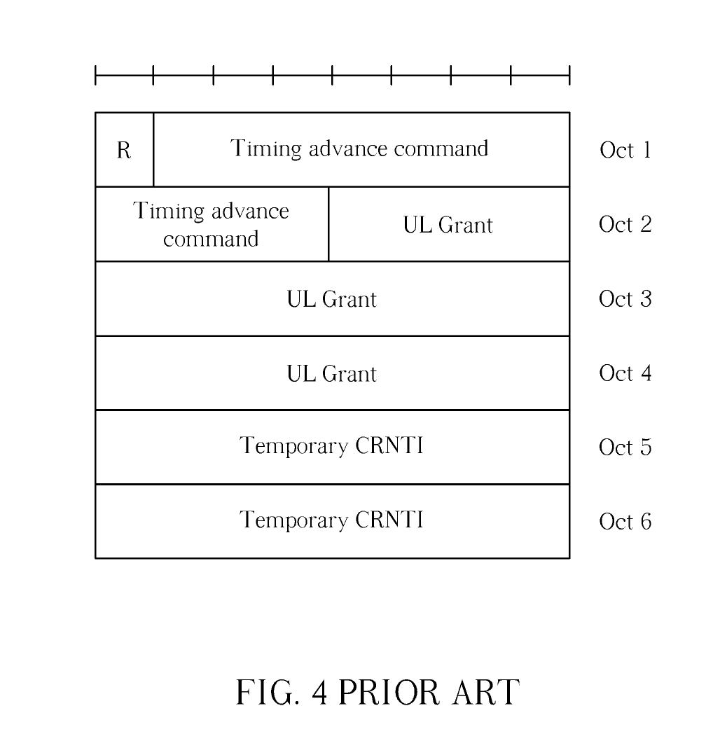

### DETAILED DESCRIPTION

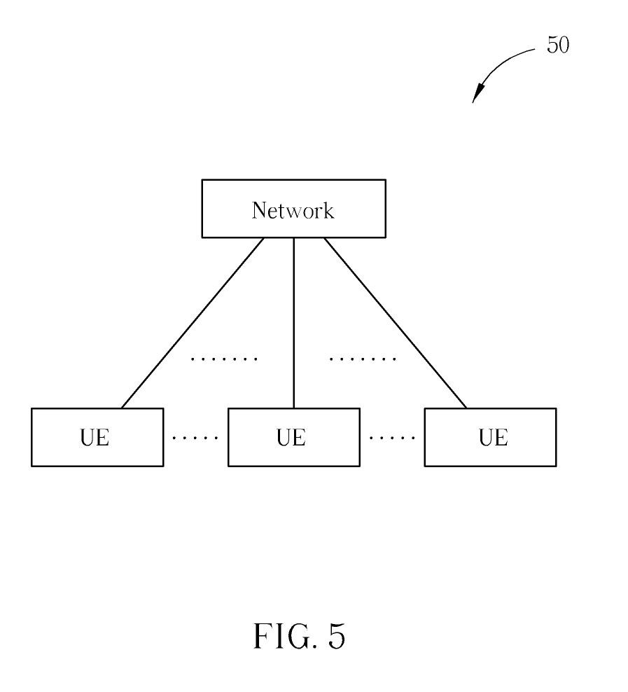

Please refer to FIG. 5, which is a schematic diagram of a wireless communication system 50 according to an example. The wireless communication system 50, such as an LTE (Long-Term Evolution) system or other mobile communication systems, is briefly composed of a network and a plurality of user equipments (UEs). Practically, the network comprising a plurality of base stations, such as an E-UTRAN (evolved-UTRAN) comprising a plurality of evolved Node-Bs (eNBs) in the LTE system. The UEs can be devices such as mobile phones, computer systems, etc. Besides, the network and the UE can be seen as a transmitter or receiver according to transmission direction, e.g., for uplink, the UE is the transmitter and the network is the receiver, and for downlink, the network is the transmitter and the UE is the receiver.

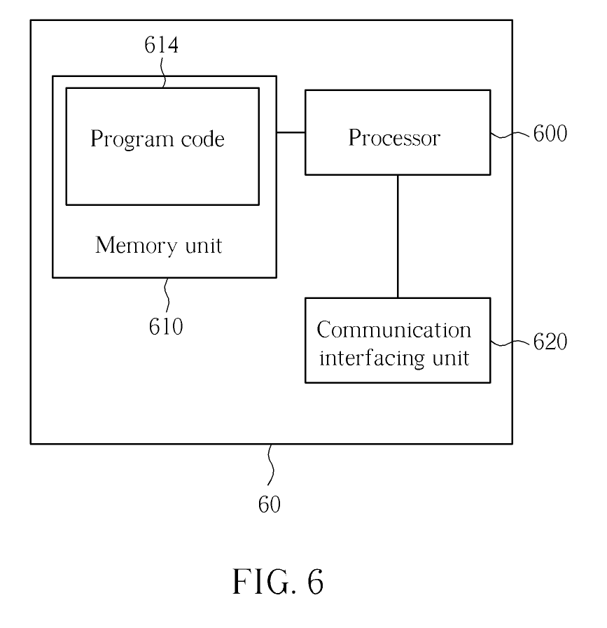

Please refer to FIG. 6, which illustrates a schematic diagram of a communication device 60 according to an example. The communication device 60 may be the mobile devices or the network shown in FIG. 5 and may include a processor 600 such as a microprocessor or ASIC, a memory unit 610 and a communication interfacing unit 620. The memory unit 610 may be any data storage device that can store program code 614 for access by the processor 600. Examples of the memory unit 610 include but are not limited to a subscriber identity module (SIM), read-only memory (ROM), random-access memory (RAM), CD-ROMs, magnetic tapes, hard disks, and optical data storage devices. The communication interfacing unit 620 may be preferably a radio transceiver and accordingly exchanges wireless signals according to processing results of the processor 600.

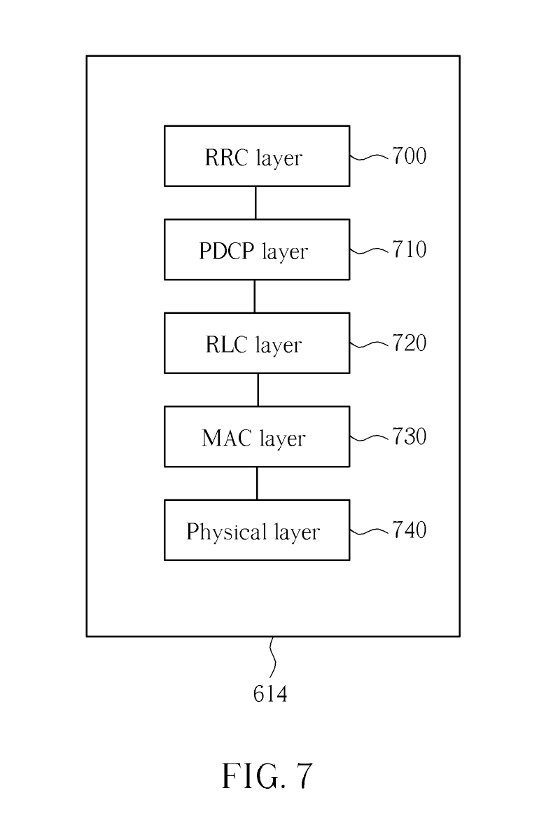

Please refer to FIG. 7, which illustrates a schematic diagram of the program code 614 for the LTE system according to an example. The program code 614 includes program code of multiple communications protocol layers, which from top to bottom are a radio resource control (RRC) layer 700, a packet data convergence protocol (PDCP) layer 710, a radio link control (RLC) layer 720, a medium access control (MAC) layer 730 and a physical (PHY) layer 740. The MAC layer 730 may provide data transfer services on logical channels for a random access (RA) procedure. When the MAC layer 730 uses a physical downlink control channel (PDCCH) to indicate radio resource allocation, a radio network temporary identifier (RNTI) mapped on the PDCCH is used depending on the logical channel type, for example, a random access radio network temporary identifier (RA-RNTI) used for a random access response of the RA procedure on a downlink share channel (DL-SCH). In some examples, the MAC layer 730 may initiate the RA procedure for a scheduling request (SR) since the mobile device shown in FIG. 5 may not have any other uplink resource dedicated to the SR. When the RA procedure is initiated by the MAC layer 730, a random access response may be sent in a MAC protocol data unit (MAC PDU) by the network. In some examples, the MAC PDU may contain one or more Backoff Indicator (BI) subheaders, which may be used for indicating a delay time for transmissions. In some examples, the MAC PDU may contain multiple random access preamble identifier (RAPID) subheaders. Each of RAPID subheader may identify an RA preamble sent by the mobile device during the RA procedure, and corresponds to one MAC RAR carrying timing information of the mobile device.

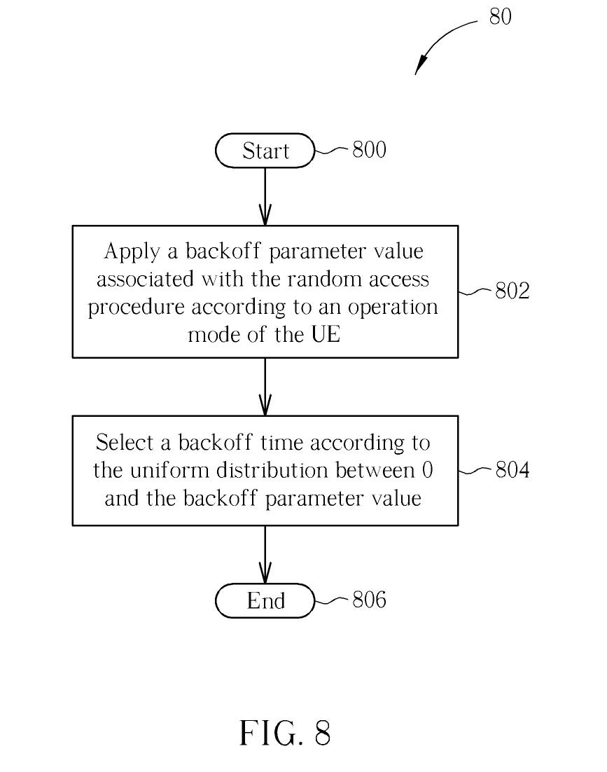

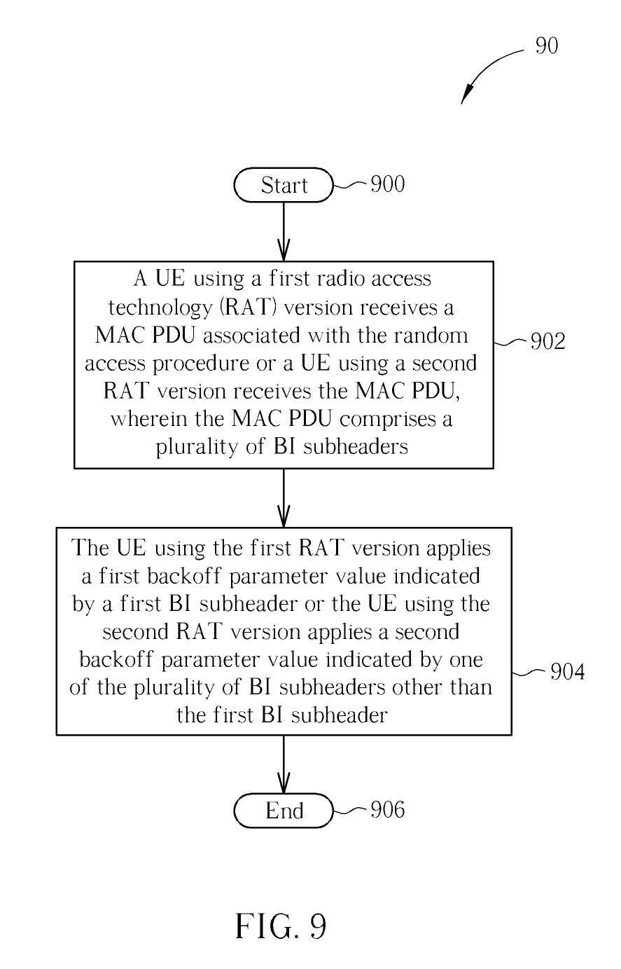

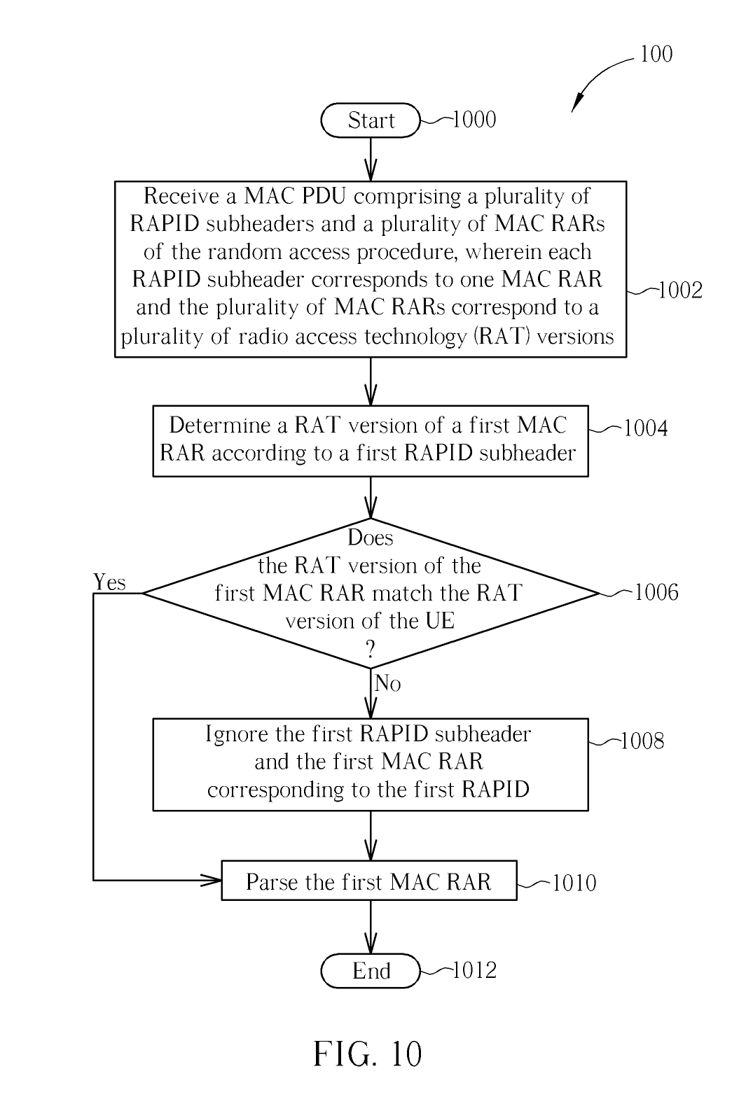

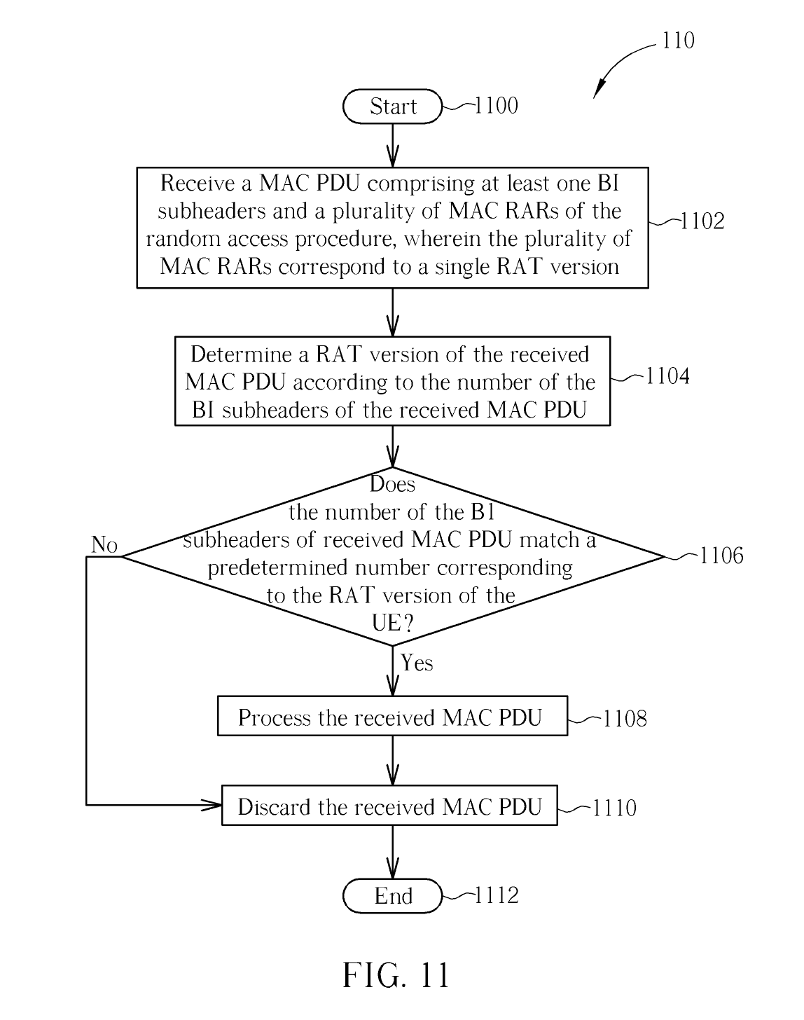

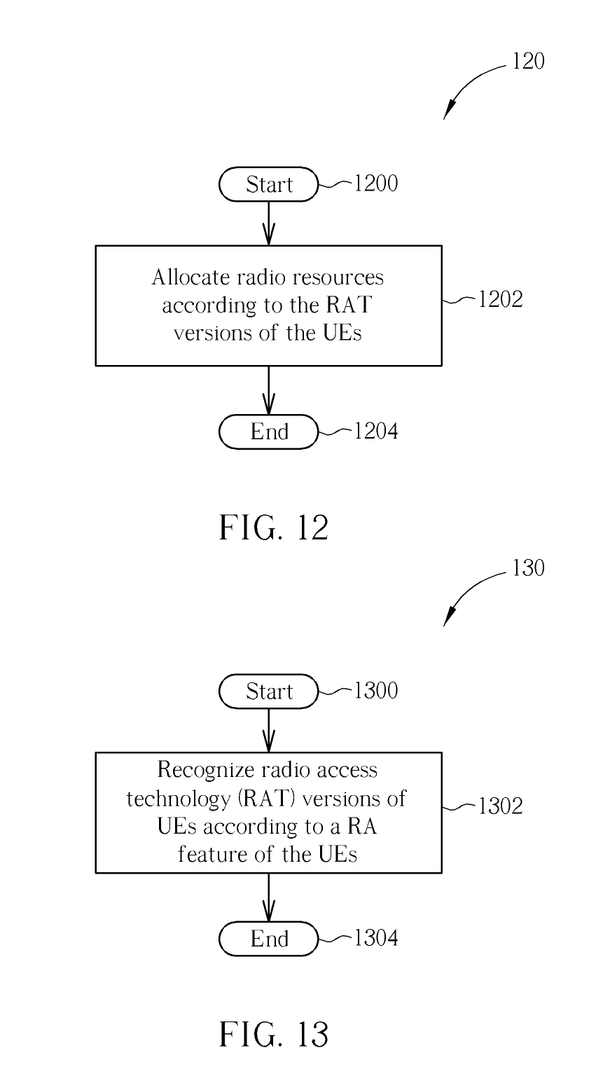

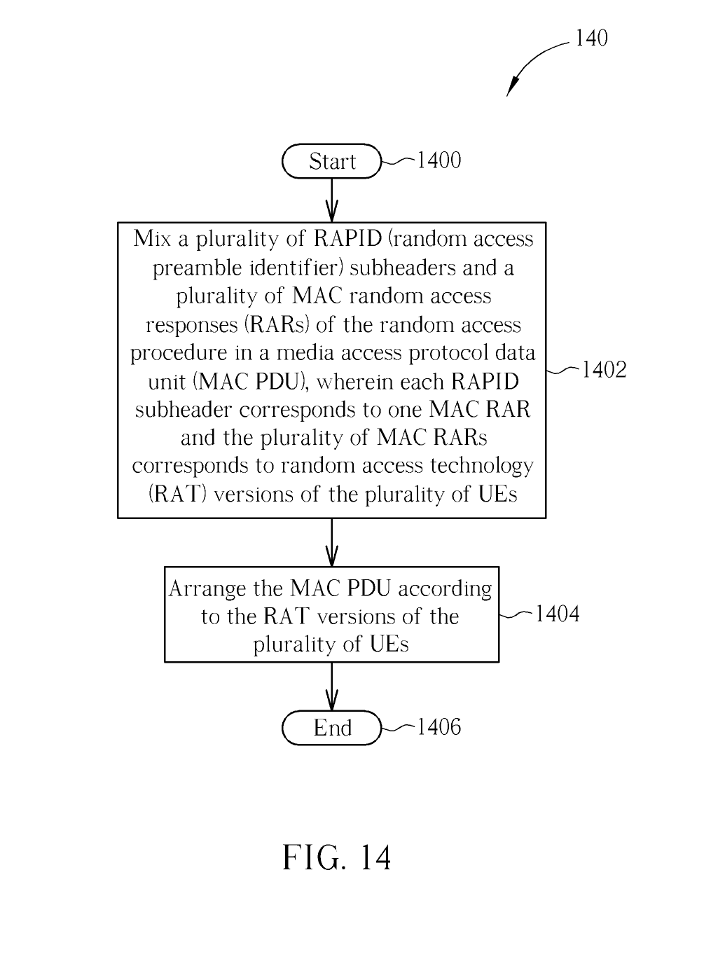

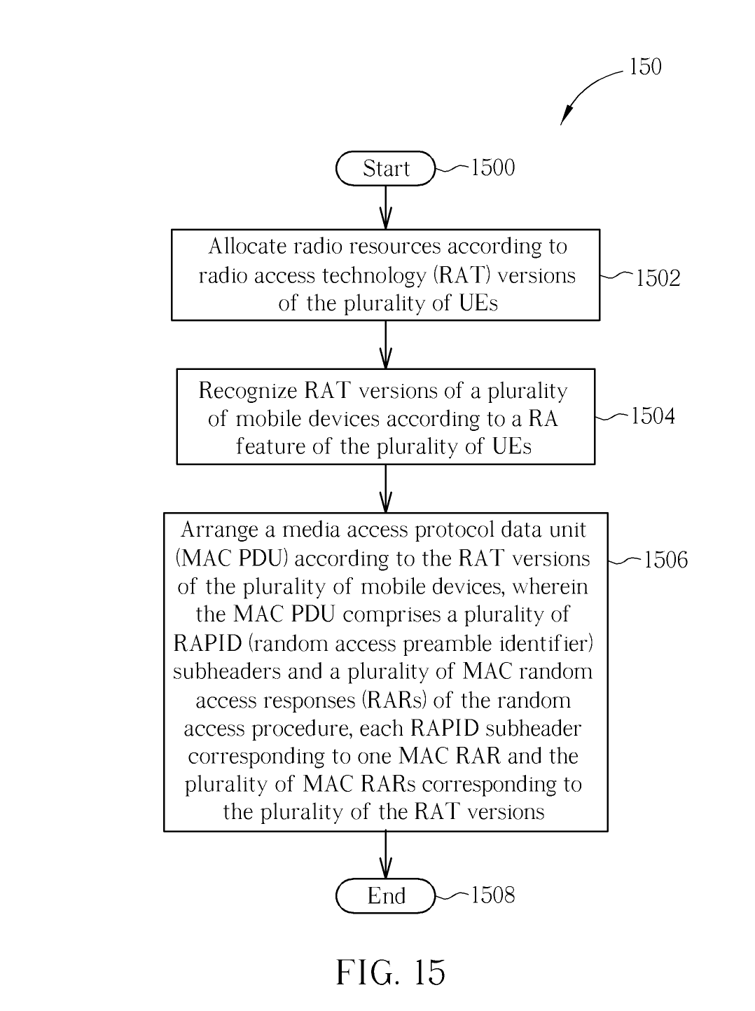

Please refer to FIG. 8, which is a flowchart of a process 80 according to an example. The process 80 is used for handling a random access procedure for a UE in a wireless communication system. The process 80 may be compiled into the program code 614 and include the following steps:

Step 800: Start.

Step 802: Apply a backoff parameter value associated with the random access procedure according to an operation mode of the UE.

Step 804: Select a backoff time according to the uniform distribution between 0 and the backoff parameter value.

Step 806: End.

According to the process 80, the UE may apply the backoff parameter value according to which mode the UE is currently operated in when the UE obtain the BI subheader included in the MAC PDU sent by the network. In other words, the UE in different operation modes (e.g. the RRC_CONNECT mode and the RRC_IDLE mode) may apply different backoff parameter values. Then the UE selects the backoff time according to the uniform distribution between 0 and the applied backoff parameter value for each time a transmission of the RA procedure needs to be performed. Once the subsequent RA procedure fails (e.g. during a subsequent RA procedure, the UE does not receive MAC RARs in a subsequent MAC PDU within a period of time or the RAIPDs in the subsequent MAC PDU does not match the RA preamble sent by the UE), based on the backoff parameter value obtained earlier, the UE may delays retransmission of the RA preamble by the backoff time. As a result, the UE in the different operation modes may delay retransmission of the RA preamble by different backoff times. It is reasonable for the UE in different operation mode to apply different backoff time since the UE in the RRC_CONNECT mode may have less collision probability than the UE in the RRC_IDLE mode.

For example, a MAC PDU may be sent by the network (e.g. eNB) during the RA procedure. In some example, the RA procedure may be initiated due to an initial connection or due to lack of dedicated scheduling request resource. The MAC PDU may comprise a BI subheader, which indicates a backoff parameter value B2. When the UE is in the RRC_IDLE mode (called RRC_IDLE UE hereinafter), the RRC_IDLE UE may apply backoff parameter value B2. When the UE is in the RRC_CONNECTED mode (called RRC_CONNECTED UE hereinafter), the RRC_CONNECTED UE applies the backoff parameter value B1 associated with the backoff parameter value B2. Thus, the RRC_CONNECTED UE may randomly select the backoff time from a range [0, B1] with equal probability. The RRC_IDLE UE may randomly select the backoff time from a range [0, B2] with equal probability. In some examples, the backoff parameter value B1 equals the second backoff parameter value B2 dived by a predetermined value X. The predetermine value X is a positive natural number and assigned by the RRC layer 700 or the MAC layer 730. Consequently, the RRC_CONNECTED UE may randomly select the backoff time from a range [0, B2/x].

In other examples, the backoff parameter value B1 equals the backoff parameter value B2. In this situation, the RRC_CONNECTED UE and the RRC_IDLE UE may both apply the backoff parameter value B2 and select the same backoff time BT from the range [0, B2]. Assuming that the RRC_IDLE UE may select a backoff time BT, the RRC_CONNECTED UE may divide the backoff time BT by the predetermined value X to obtain a new backoff time BT1. In other words, when the subsequent RA procedure fails, the RRC_IDLE UE may delay retransmission of the RA preamble by the backoff time BT, and the RRC_CONNECTED UE may delay retransmission of the RA preamble by the bakoff time BT1. Hence, the transmission times of the RRC_IDLE UE and the RRC_CONNECTED UE are staggered in the situation of the same backoff parameter value.

Thus, the abovementioned examples allow the RRC_CONNECTED UE to select backoff time from a smaller window. This can reduce delay for RA preamble, thereby enhancing efficiency of the RA procedure.

Please refer to FIG. 9, which is a flowchart of a process 90 according to an example. The process 90 is used for handling a random access procedure for a UE in a wireless communication system. The process 90 may be compiled into the program code 614 and include the following steps:

Step 900: Start.

Step 902: A UE using a first radio access technology (RAT) version receives a MAC PDU associated with the random access procedure or a UE using a second RAT version receives the MAC PDU, wherein the MAC PDU comprises a plurality of BI subheaders.

Step 904: The UE using the first RAT version applies a first backoff parameter value indicated by a first BI subheader or the UE using the second RAT version applies a second backoff parameter value indicated by one of the plurality of BI subheaders other than the first BI subheader.

Step 906: End.

According to the process 90, when the MAC PDU comprises multiple BI subheaders, the UEs using different RAT versions (e.g., releases 8 and 9 of the LTE protocols, Rel-8/9) may apply the different BI parameter values indicated by the different BI subheaders. Thus, based on the different BI parameter values, the UEs using different RAT versions may delay transmissions by the different backoff times since the UEs using different RAT versions may have different collision probabilities.

For example, a MAC PDU comprises BI subheaders BI1, BI2 . . . BI10. When an RAT_V1 UE (the UE with the first RAT version) receives the MAC PDU, the RAT_V1 UE may apply a BI parameter value indicated by the BI subheader BI1. When an RAT_V2 UE (the UE with the second RAT version) receives the MAC PDU, the RAT_V2 UE may apply a BI parameter value indicated by the BI subheader BI2. In some examples, the RAT_V1 UE may apply a BI parameter value indicated by the BI subheader BI10, and the RAT_V2 UE may apply a BI parameter value indicated by the BI subheader BI9. Please note that it is not restricted that the RAT_V1 UE can only select the BI subheaders BI1 or BI10 and the RAT_V2 UE can only select the BI subheaders BI2 or BI9 as long as the RAT_V1 UE and the RAT_V2 UE select different BI subheaders, and apply different BI parameter values as indicated in the different BI subheaders.

In addition, the BI subheader may comprise multiple reserved bits. The combination of the reserved bits may be used to correspond to the RAT version. In this situation, the RAT_V1 UE (e.g. Rel-8 UE) may ignore the reserved bits included in the BI subheader BI1. The RAT_V2 UE (e.g. Rel-9 UE) may check a combination of reserved bits included in the BI subheader BI2 first. When the combination of reserved bits included in the BI subheader BI2 does not match the RAT version of the RAT_V2 UE, the RAT_V2 UE may ignore the BI subheader BI2. For example, Reserved bits [00] may indicate that the BI subheader corresponds to the Rel-9 UE and reserved bits [01] may indicate that the BI subheader corresponds to the Rel-10 UE. Thus, when the Rel-8 UE receives the MAC PDU, the Rel-8 UE may apply a BI parameter value as indicated in the BI subheader BI1 and ignore the reserved bits in the BI subheader BI1. When the Rel-9 UE receives the MAC PDU, the Rel-9 UE may check combination of the reserved bits included in the BI subheader BI2. If the combination of the reserved bits shows [00], the Rel-9 UE may apply the BI parameter value as indicated in the B1 subheader B2. If the combination of the reserved bits shows [01], the Rel-9 UE may ignore the B1 subheader B2 since the reserved bits [01] represents that the B1 subheader B2 belongs to a Rel-10 UE.

Consequently, the UEs using different RAT versions apply BI parameter values as indicated in the different BI subheaders. Also, the UE may distinguish its BI subheader according to reserved bits included in the BI subheader.

Please refer to FIG. 10, which is a flowchart of a process 100 according to an example. The process 100 is used for handling a random access procedure for a UE in a wireless communication system. The process 100 may be compiled into the program code 614 and include the following steps:

Step 1000: Start.

Step 1002: Receive a MAC PDU comprising a plurality of RAPID subheaders and a plurality of MAC RARs of the random access procedure, wherein each RAPID subheader corresponds to one MAC RAR and the plurality of MAC RARs correspond to a plurality of radio access technology (RAT) versions.

Step 1004: Determine a RAT version of a first MAC RAR according to a first RAPID subheader.

Step 1006: “Does the RAT version of the first MAC RAR match the RAT version of the UE?” If yes, go to the Step 1010; otherwise, go to the Step 1008.

Step 1008: Ignore the first RAPID subheader and the first MAC RAR corresponding to the first RAPID.

Step 1010: Parse the first MAC RAR.

Step 1012: End.

According to the process 100, the UE may determine the RAT version of the first MAC RAR according to the first RAPID subheader after receiving the MAC PDU. The MAC PDU includes RAPID subheaders and MAC RARs corresponding to different RAT versions. Then, the UE may ignore the first RAPID subheader and the first MAC RAR when the RAT version of the first MAC RAR does not match the RAT version of the UE. The UE may parse the first MAC RAR when the RAT version of the first MAC RAR matches the RAT version of the UE. In other words, when the MAC RARs and RAPID subheaders of the different RAT versions are mixed in the MAC PDU, the UE may check the value of the first RAPID subheader with the predetermined range since the value of the RAPID subheader for different RAT versions of UEs may fall within the different ranges. When the value of the first RAPID subheader does not fall within the predetermined range, the UE may determine that the RAT version of the first MAC RAR does not match the RAT version of the UE. When the value of the first RAPID subheader falls within the predetermined range, the UE may determine that the RAT version of the first MAC RAR matches the RAT version of the mobile device. When the RAT version of the first MAC RAR does not match the RAT version of the UE, the UE may ignore the first RAPID subheader and the first MAC RAR corresponding to the first RAPID. When the RAT version of the first MAC RAR matches the RAT version of the UE, the UE may parse the first MAC RAR by a predetermined format corresponding to the RAT version of the UE. In some examples, the UE may be a Rel-8 UE. The Rel-8 UE may parse the first MAC RAR by a Rel-8 MAC RAR format. In some examples, the UE may be a Rel-9 UE. The Rel-9 UE may parse the first MAC RAR by a new MAC RAR format.

In addition, the UE may determine validity of the first MAC RAR according to format of the first MAC RAR when the RAT version of the first MAC RAR matches the RAT version of the UE. To be more specific, the UE may verify a timing advance (TA) command field, an uplink (UL) grant field, and a temporary cell radio network temporary identifier (C-RNTI) field of the first MAC RAR, or check the length of the first MAC RAR. The UE may compare values or length of those fields (the TA command field, the UL grant field, and the C-RNTI field) with a predetermined format, which corresponds to the RAT version of the UE. In some examples, the UE may be referred to a Rel-8 UE, and then the predetermined format may be Rel-8 MAC RAR format. In some examples, the UE may be referred to a Rel-9 UE, and then the predetermined format may be a Rel-9 MAC RAR format different from the Rel-8 MAC RAR format. The Rel-9 MAC RAR format may include other fields than the TA command field, the UL grant field, and the C-RNTI field. Once the at least one field of the first MAC RAR format does not match the corresponding fields of the predetermined format, the UE may determine that the first MAC RAR is invalid. For example, the TA command field of may be determined to be invalid if the filed value is out of the 0-1282 range. Since the Rel-9 MAC RAR format may include more fields, the Rel-9 UE may check the format length of the first MAC RAR first. If the format of the first MAC RAR does not have the same length as the Rel-9 format does, the Rel-9 UE may determine that the first MAC RAR is invalid.

In some examples, the first MAC RAR may comprise a reserved bit, which may be used for indicating the predetermined format of which RAT version should be applied to the first MAC RAR. Under this circumstance, the UE may check the reserved bit to determine the validity of the first MAC RAR, based on the RAT version of the UE. For example, the reserved bit [0] may be denoted as the Rel-9 MAC RAR format, and the reserved bit [1] may be denoted as the Rel-10 MAC RAR format. Then, the Rel-9 UE may check the reserved bit of the first MAC RAR. When the reserved bit of the first MAC RAR shows [0], the Rel-9 UE may determine that the first MAC RAR is valid. When the reserved bit shows [1], the Rel-9 UE may determine that the first MAC RAR is invalid.

In some examples, after the UE determine the validity of the first MAC RAR, the UE may ignore the first RAPID subheader as well as the first MAC RAR and continue to verify the rest of the MAC RARs when the first MAC RAR is invalid. Or the UE may parse the first MAC RAR by the predetermined format and stop verifying the rest of the MAC RARs when the first MAC RAR is valid. The UE may determine the MAC PDU contain one or more its MAC RAR, so there is no need to verify the rest of MAC RARs.

Therefore, when the network mixes the MAC RARs and RAPID subheaders of the different RAT versions in one MAC PDU, the UE may determine the RAT version of the MAC RARs, thereby locating a correct MAC RAR or ignoring a wrong MAC RAR.

Please refer to FIG. 11, which is a flowchart of a process 110 according to an example. The process 110 is used for handling a random access procedure for a UE in a wireless communication system. The process 110 may be compiled into the program code 614 and include the following steps:

Step 1100: Start.

Step 1102: Receive a MAC PDU comprising at least one BI subheaders and a plurality of MAC RARs of the random access procedure, wherein the plurality of MAC RARs correspond to a single RAT version.

Step 1104: Determine a RAT version of the received MAC PDU according to the number of the BI subheaders of the received MAC PDU.

Step 1106: “Does the number of the BI subheader of the received MAC PDU match a predetermined number corresponding to the RAT version of the UE?” If yes, go to the Step 1108; otherwise, go to the Step 1110.

Step 1108: Process the received MAC PDU.

Step 1110: Discard the received MAC PDU.

Step 1112: End.

According to the process 110, when the MAC PDU comprising MAC RARs corresponding to one RAT version is received, the UE may determine the RAT version of the received MAC PDU according to the number of the BI subheaders of the received MAC PDU since the MAC PDU corresponding to different RAT versions may comprise the different numbers of BI subheaders. Then, the UE may discard the received MAC PDU when the number of the BI subheader of received MAC PDU does not match the predetermined number corresponding to the RAT version of the UE. On the contrary, the UE may process the received MAC PDU when the number of the BI subheader of received MAC PDU matches the predetermined number corresponding to the RAT version of the UE. Therefore, the UE may determine the RAT version of the MAC PDU, thereby processing a correct MAC PDU or discarding a wrong MAC PDU.

For example, a Rel-8 MAC PDU may comprise only one subheader, and a Rel-9 MAC PDU may comprise two subheaders. When a Rel-9 UE receives the Rel-8 MAC PDU, the Rel-9 UE may check the BI subheader number of the Rel-8 MAC PDU and find that there is only one subheader in the Rel-8 MAC PDU. Thus, the Rel-9 UE determines that the Rel-8 MAC PDU does not belong to it and may discard the Rel-8 MAC PDU. When the Rel-9 UE receives the Rel-9 MAC PDU, the Rel-9 UE may check the BI subheader number of the Rel-9 MAC PDU and find that there are two subheaders in the Rel-9 MAC PDU. Thus, the Rel-9 UE may determine that the Rel-9 MAC PDU belongs to it and then start to process the Rel-9 MAC PDU. In some examples, a look-up table may be established for demonstrating the mapping between the RAT version and the number of the BI subheader.

In other examples, the UE may determine the RAT version of the received MAC PDU according to a range of a random access-radio network temporary identifier (RA-RNTI) since the UE using different RAT versions may use the different RA-RNTIs for the RA preamble transmission. For example, the RA-RNTI may be expressed by: RA-RNTI=t_id+10*f_id. The Rel-8 UE may use the odd values of t_ids and the Rel-9 UE may use the even values of t_ids. Therefore, when the MAC PDU identified by the RA-RNTI is sent, the UE may check whether the RA-RNTI falls within a legal range and thereby determine whether the MAC PDU belongs to the UE itself.

Besides, the UE may determine the RAT version of the received MAC PDU by checking a length of the received MAC PDU with a predetermined value since the total lengths of the received MAC PDUs differ when the RAT versions of the received MAC PDUs differ. Then, the UE may discard the received MAC PDU when the length of the received MAC PDU does not match the predetermined value. On the contrary, the UE may process the received MAC PDU when the length of the received MAC PDU matches the predetermined value. For example, the total length for the received MAC PDU may be expressed by: N_{BI}+(7*N_{RAR}) byte; wherein N_{BI} is the number of the BI subheader (N_{BI}=1, for the Rel-8 MAC PDU) and N_{RAR} is the number of the MAC RAR included in the received MAC PDU (N_{RAR}>=0). The valid length of the Rel-8 MAC PDU may be defined as 1, 8, 15 . . . etc.

Furthermore, the UE may determine a RAT version of the received MAC PDU according to reserved bits of the BI subheaders or according to reserved bits of the MAC RARs since combination of the reserved bits of the BI subheaders or the reserved bits of the MAC RARs may be used for indicating whether the received MAC PDU corresponds to the RAT version of the UE. Then, the UE may discard the received MAC PDU when combination of the reserved bits of the BI subheaders or of the MAC RARs does not match a predetermined combination corresponding to the RAT version of the UE. On the contrary, the UE may process the received MAC PDU when combination of the reserved bits of the BI subheaders or of the MAC RARs matches the predetermined combination corresponding to the RAT version of the UE.

For example, a MAC PDU comprising MAC RARs corresponding to one RAT version is received by the UE. The UE may be referred as to the Rel-9 UE in the LTE system. The MAC PDU may comprise two BI subheaders. Two reserved bits may be included in each of the BI subheaders. Reserved bits [00] may indicate that the MAC PDU is the Rel-9 MAC PDU and reserved bits [01] may indicate that the MAC PDU is the Rel-10 MAC PDU. When the Rel-9 UE receives the MAC PDU, the Rel-9 UE may check combination of the reserved bits included in the BI subheaders. If the combination of the reserved bits shows [00], the Rel-9 UE may process the received MAC PDU. If the combination of the reserved bits shows [01], the Rel-9 UE may discard the received MAC PDU.

For another example, a MAC PDU comprising MAC RARs corresponding to one RAT version is received by the UE. The UE may be referred as to the Rel-9 UE in the LTE system. Each of MAC RAR may comprise a reserved bit, which is used for indicating the RAT version of the received MAC PDU. The reserved bit [0] may indicate that the MAC PDU is the Rel-9 MAC PDU, and the reserved bit [1] may indicate that the MAC PDU is the Rel-10 MAC PDU. When the Rel-9 UE receives the MAC PDU, the Rel-9 UE may check the reserved bit of the MAC RAR. If the reserved bit shows [0], the Rel-9 UE may process the received MAC PDU. If the reserved bit shows [1], the Rel-9 UE may discard the received MAC PDU.

Thus, according to the aforementioned examples, when the UE receive the MAC PDU comprising at least one BI subheader and MAC RARs corresponding to a single RAT version, the UE processes a correct MAC PDU or discards a wrong MAC PDU by determining the RAT version of the MAC PDU.

Please refer to FIG. 12, which is a flowchart of a process 120 according to an example. The process 120 is used for handling a random access procedure for a network in a wireless communication system. The process 120 may be compiled into the program code 614 and include the following steps:

Step 1200: Start.

Step 1202: Allocate radio resources according to the RAT versions of the UEs.

Step 1204: End.

According to the process 120, when the random access procedure is initiated, the network may allocate the radio resource according to the RAT version. In other words, the network may allocate the different radio resources to the UEs using the different RAT versions. In this situation, the UEs using the different RAT versions may use RA-RNTIs confined in the different specific ranges for preamble transmission. For example, the RA-RNTI may be expressed by: RA-RNTI=t_id+10*f_id. The Rel-8 UE may use the odd values of t_ids for corresponding RA-RNTI and the Rel-9 UE may use the even values of t_ids. Therefore, the UE may determine the RAT version of the received MAC PDU according to the range of the RA-RNTI.

Please refer to FIG. 13, which is a flowchart of a process 130 according to an example. The process 130 is used for handling a random access procedure for a network in a wireless communication system. The process 130 may be compiled into the program code 214 and include the following steps:

Step 1300: Start.

Step 1302: Recognize radio access technology (RAT) versions of UEs according to a RA feature of the UEs.

Step 1304: End.

According to the process 130, the network may recognize the RAT version of the UEs according to the RA feature of the UEs. In some examples, the RA feature may be referred as to a RA preamble sent by the UE. After receiving the RA preamble, the network may determine the RAT version of the UE according to the range of the RA preamble. In other words, the network may determine the RAT version of the UE according to the RA preamble. In some examples, the RA feature may be referred as to a RAPID. Since the RAPID corresponds to the RA preamble sent by the UE, the network may obtain information about the frequency domain resource and time domain resource used by the UE, and further may determine the RAT version of the UE according to the information about the frequency domain resource and time domain resource.

Please refer to FIG. 14, which is a flowchart of a process 140 according to an example. The process 140 is used for handling a random access procedure for a network in a wireless communication system. The process 140 may be compiled into the program code 614 and include the following steps:

Step 1400: Start.

Step 1402: Mix a plurality of RAPID (random access preamble identifier) subheaders and a plurality of MAC random access responses (RARs) of the random access procedure in a media access protocol data unit (MAC PDU), wherein each RAPID subheader corresponds to one MAC RAR and the plurality of MAC RARs corresponds to random access technology (RAT) versions of the plurality of UEs.

Step 1404: Arrange the MAC PDU according to the RAT versions of the plurality of UEs.

Step 1406: End.

According to the process 140, the network may mix the different RAT version RAPID subheaders and MAC RARs in the MAC PDU. Then the network may arrange the MAC PDU according to the RAT versions of the plurality of UEs. In other words, the network may arrange order of the RAPID subheaders and the MAC RARs according to the RAT versions. In some examples, the network may arrange the RAPID subheaders and MAC RARs corresponding to a first RAT version all in front of the RAPID subheaders and MAC RARs corresponding to a second RAT version. In some examples, the network may pad the MAC RARs corresponding to the second RAT version to the end of the MAC PDU. Consequently, when the UE using the second RAT version intends to find any RAPID subheader matches the second RAT version, the UE may go straight to the end of the MAC PDU for verification, thereby avoiding verifying each of MAC RAR from the beginning of the MAC PDU.

Please refer to FIG. 15, which is a flowchart of a process 150 according to an example. The process 150 is used for handling a random access procedure for a network in a wireless communication system. The process 150 may be compiled into the program code 614 and include the following steps:

Step 1500: Start.

Step 1502: Allocate radio resources according to radio access technology (RAT) versions of the plurality of UEs.

Step 1504: Recognize RAT versions of a plurality of mobile devices according to a RA feature of the plurality of UEs.

Step 1506: Arrange a media access protocol data unit (MAC PDU) according to the RAT versions of the plurality of mobile devices, wherein the MAC PDU comprises a plurality of RAPID (random access preamble identifier) subheaders and a plurality of MAC random access responses (RARs) of the random access procedure, each RAPID subheader corresponding to one MAC RAR and the plurality of MAC RARs corresponding to the plurality of the RAT versions.

Step 1508: End.

The process 150 may be seen as a summarized process for the network, combining the process 120, the process 130 and the process 140. Therefore, the detail description can be found above and thus is omitted herein.

Please note that the steps of the abovementioned processes, including suggested steps, can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 60 in which the processor 600 processes the program code 614 related to the above-mentioned processes and the processed results can handle handling a random access procedure in a wireless communication system.

To sum up, according to the examples, the UE in the different operation modes may apply the different BI parameter values and delay retransmission of the RA preambles by the different backoff times; the UEs using different RAT versions may apply BI parameter values indicated in the different BI subheaders when the received MAC PDU have multiple BI subheaders; the UE may determine the RAT versions of the RAPID subheaders and the MAC RARs and parse/ignore the MAC RARs when the MAC PDU combines the different RAT version RAPID subheaders and MAC RARs; the UE may determine the RAT version of the MAC PDU and process/discard the MAC PDU when the MAC RARs in the MAC PDU corresponds to a single RAT version; the network may allocate the different radio resource to the UEs using the different RAT versions; the network may arrange an order of the RAPID subheaders and MAC RARs according to the RAT versions of the RAPID subheaders and MAC RARs. Thus the UE may apply the appropriate backoff time and interpret the correct MAC RAR.

Those skilled in the art will readily observe that numerous modifications and alterations of the device and method may be made while retaining the teachings and the scope of the invention. Accordingly, the above disclosure should be construed as limited only by the metes and bounds of the appended claims.

What is claimed is:

1. A method of handling a random access procedure for a mobile device in a wireless communication system, the method comprising the steps of:
applying a backoff parameter value associated with the random access procedure according to an operation mode of the mobile device; and
selecting a backoff time according to a uniform distribution between 0 and the backoff parameter value.

2. The method of claim 1, wherein the step of applying the backoff parameter value according to the operation mode of the mobile device comprises:
applying a first backoff parameter value when the operation mode of the mobile device is an RRC_CONNECTED mode; and
applying a second backoff parameter value when the operation mode of the mobile device is an RRC_IDLE mode.

3. A method of handling a random access procedure for a mobile device in a wireless communication system, the method comprising the steps of:
receiving a media access control protocol data unit (MAC PDU) associated with the random access procedure, wherein the MAC PDU comprises a plurality of backoff indicator (BI) subheaders and each of the plurality of BI subheaders comprises a reserved bit combination corresponding to a radio access technology (RAT) version;
checking a first reserved bit combination of a first BI subheader; and
applying a backoff parameter value indicated by the first BI subheader when a first RAT version corresponding to the first reserved bit combination matches an RAT version of the mobile device.

4. A method of handling a random access procedure for a mobile device in a wireless communication system, the method comprising the steps of:
using a first radio access technology (RAT) version and receiving a media access control protocol data unit (MAC PDU) associated with the random access procedure, wherein the MAC PDU comprises a plurality of backoff indicator (BI) subheaders; or
using a second RAT version and receiving the MAC PDU associated with the random access procedure; and
applying a first backoff parameter value indicated by a first BI subheader when using the first RAT version; or
applying a second backoff parameter value indicated by a second BI subheader when using the second RAT version.

5. The method of claim 4, wherein the MAC PDU comprises a plurality of reserved bit combinations corresponding to the plurality of BI subheaders.

6. The method of claim 5, wherein the step of using the first RAT version and receiving the MAC PDU associated with the random access procedure comprises ignoring reserved bit combinations corresponding to the plurality of BI subheaders.

7. The method of claim 5, wherein the step of using the second RAT version and receiving the MAC PDU associated with the random access procedure comprises:
checking a reserved bit combination corresponding to the second BI subheader; and
ignoring the second BI subheader when corresponding reserved bit combination indicates a RAT version not matching the second RAT version.

8. The method of claim 5, wherein the mobile devices using the second RAT version applying the second backoff parameter value indicated by one of the plurality of BI subheaders other than the first BI subheader comprises:
the mobile devices using the second RAT version applying the second backoff parameter value when corresponding reserved bit combination indicates a RAT version matching the second RAT version.

9. A method of handling a random access (RA) procedure for a mobile device in a wireless communication system, the method comprising the steps of:
receiving a media access control (MAC) protocol data unit (PDU) comprising a plurality of RAPID (random access preamble identifier) subheaders and a plurality of MAC random access responses (RARs) associated with the random access procedure, wherein each RAPID subheader corresponds to one MAC RAR and the plurality of MAC RARs correspond to a plurality of radio access technology (RAT) versions;
determining a RAT version of a first MAC RAR according to a first RAPID subheader, first MAC RAR corresponding to the first RAPID subheader; and
ignoring the first RAPID subheader and the first MAC RAR corresponding to the first RAPID when the RAT version of the first MAC RAR does not match the RAT version of the mobile device.

10. The method of claim 9, wherein the step of determining the RAT version of the first MAC RAR according to the first RAPID subheader comprises the step of determining the RAT version of the first MAC RAR by checking a range of the first RAPID subheader with a predetermined range.

11. The method of claim 10 further comprising:
determining that the RAT version of the first MAC RAR does not match the RAT version of the mobile device when the range of the first RAPID subheader does not match the predetermined range; and
determining that the RAT version of the first MAC RAR matches the RAT version of the mobile device when the range of the first RAPID subheader matches the predetermined range.

12. The method of claim 11 further comprising parsing the first MAC RAR by a predetermined format corresponding to the RAT version of the mobile device when the RAT version of the first MAC RAR matches the RAT version of the mobile device.

13. The method of claim 9 further comprising:
determining validity of the first MAC RAR according to a format of the first MAC RAR when the RAT version of the first MAC RAR matches the RAT version of the mobile device;
ignoring the first RAPID subheader and the first MAC RAR when the first MAC RAR is invalid; and
parsing the first MAC RAR by a predetermined format when the first MAC RAR is valid, the predetermined format corresponding to the RAT version of the mobile device.

14. The method of claim 13, wherein the step of determining validity of the first MAC RAR according to the format of the first MAC RAR:
verifying a timing advance (TA) command field of the first MAC RAR according to the predetermined format;
verifying an uplink (UL) grant field of the first MAC RAR according to the predetermined format; and
verifying a temporary cell radio network temporary identifier (C-RNTI) field of the first MAC RAR according to the predetermined format.

15. The method of claim 13 further comprising the step of ignoring a reserved bit of the first MAC RAR.

16. The method of claim 13 further comprising the step of determining a RAT version of the first MAC RAR.

17. The method of claim 13, wherein the step of determining the validity of the first MAC RAR according to the format of the first MAC RAR comprises determining that the first MAC RAR is invalid when at least one field of the first MAC RAR is invalid.

18. The method of claim 13 further comprising the steps of
stopping verifying the rest of the plurality of MAC RARs when the first MAC RAR is valid; and
continuing to verify the rest of the plurality of MAC RARs when the first MAC RAR is invalid.

19. The method of claim 13, wherein the format of the first MAC RAR comprises a length of the first MAC RAR.

20. A method of handling a random access procedure for a mobile device in a wireless communication system, the method comprising the steps of:
receiving a media access control (MAC) protocol data unit (PDU) comprising at least one backoff indicator (BI) subheaders and a plurality of MAC random access responses (RARs) associated with the random access procedure, wherein the plurality of MAC RARs correspond to a single radio access technology (RAT) version; and
determining a RAT version of the received MAC PDU according to the number of the BI subheaders of the received MAC PDU.

21. The method of claim 20 further comprising
discarding the received MAC PDU when the number of the BI subheaders of the received MAC PDU does not match a predetermined number corresponding to the RAT version of the mobile device; and
processing the received MAC PDU when the number of the BI subheaders of the received MAC PDU matches the predetermined number corresponding to the RAT version of the mobile device.

22. The method of claim 20 further comprising:
checking a length of the received MAC PDU with a predetermined value corresponding to the RAT version of the mobile device;
discarding the received MAC PDU when the length of the received MAC PDU does not match the predetermined value corresponding to the RAT version of the mobile device; and
processing the received MAC PDU when the length of the received MAC PDU matches the predetermined value corresponding to the RAT version of the mobile device.

23. The method of claim 20 further comprising:
determining the RAT version of the received MAC PDU according to reserved bit combinations of the BI subheaders or according to reserved bits of the MAC RARs;
discarding the received MAC PDU when the reserved bit combinations of the BI subheaders or the reserve bits of the MAC RARs does not match a predetermined combination or a predetermined reserved bit value corresponding to the RAT version of the mobile device; and
processing the received MAC PDU when the reserved bit combinations of the BI subheaders and the reserved bits of the MAC RARs matches the predetermined combination and the predetermined reserved bit value corresponding to the RAT version of the mobile device.

24. The method of claim 20 further comprising:
determining the RAT version of the received MAC PDU according to a random access-radio network temporary identifier (RA-RNTI);
discarding the received MAC PDU when a range of the RA-RNTI does not match a predetermined range corresponding to the RAT version of the mobile device; and
processing the received MAC PDU when the range of the RA-RNTI matches the predetermined range corresponding to the RAT version of the mobile device.

25. A method of handling a random access procedure for a network in a wireless communication system, the method comprising the steps of:
allocating radio resources according to radio access technology (RAT) versions of the plurality of mobile devices;
recognizing the RAT versions of a plurality of mobile devices according to a RA feature of the plurality of mobile devices; and
arranging a media access protocol data unit (MAC PDU) according the RAT versions of the plurality of mobile devices, wherein the MAC PDU comprises a plurality of RAPID (random access preamble identifier) subheaders and a plurality of MAC random access responses (RARs) associated with the random access procedure, each RAPID subheader corresponding to one MAC RAR and the plurality of MAC RARs corresponding to the plurality of the RAT versions.

26. The method of claim 25, wherein the RA feature comprises at least one of a RA preamble and a RAPID value.

27. The method of claim 25, wherein the step of arranging the MAC PDU according the RAT versions of the plurality of mobile devices comprises arranging an order of the RAPID subheaders and the MAC RARs according to the RAT versions of the plurality of the mobile devices.

28. The method of claim 27, wherein the order of the RAPID subheaders and the MAC RARs comprise that the RAPID subheaders and MAC RARs corresponding to a first RAT version are arranged in front of RAPID subheader and MAC RARs corresponding to a second RAT version.

29. The method of claim 27, wherein the order of the RAPID subheaders and the MAC RARs comprises that MAC RARs corresponding to a third RAT version are padded to the end of the MAC PDU.
